(19) United States
(12) Patent Application Publication
(10) Pub. No.: US 2004/0007788 A1
(43) Pub. Date: Jan. 15, 2004

(54) Carburetor air-fuel mixture adjustment assembly

(76) Inventor: Giovanni Vimercati, Verano Brianza (IT)

Correspondence Address: REISING, ETHINGTON, BARNES, KISSELLE, P.C., P O BOX 4390, TROY, MI, 48099-4390, US

(21) Appl. No.: 10/341,648

(22) Filed: Jan. 14, 2003

Related U.S. Application Data
(60) Provisional application No. 60/395,030, filed on Jul. 11, 2002.

(51) Int. Cl. F02M 19/04

(52) U.S. Cl. 261/71; 261/DIG. 84

(57) ABSTRACT

An apparatus for adjusting the air-fuel ratio of a fuel mixture to be supplied to an engine. The apparatus has a needle valve body and a receptacle formed in a main body of a carburetor which receives the needle valve body. The needle valve body has a needle and a head. The needle is axially movable relative to a needle orifice. The needle may be axially advanced and retracted by rotating the needle valve body within the receptacle to respectively decrease and increase the flow of the fuel mixture around the needle and through the orifice. To prevent tampering with the needle valve body setting, the head of the needle valve body has an unconventional shape requiring a specialized tool to rotatably adjust the needle valve body. To further prevent tampering, the head is recessed with the main body of the carburetor. A generally annular retainer is disposed concentrically on the needle valve body and laterally biases the needle valve body into engagement with the receptacle to maintain alignment of the needle valve body relative to the receptacle. The retainer assures that a constant fuel calibration setting is maintained through the orifice by resisting needle displacement due to such factors as external forces applied to the head of the needle valve body or engine vibration.

### REFERENCE TO RELATED APPLICATION

Applicant claims the benefit of provisional application, Ser. No. 60/395,030 filed Jul. 11, 2002.

### TECHNICAL FIELD

This invention relates generally to a carburetor fuel mixture adjustment assembly for adjusting the air-fuel ratio of a fuel mixture to be supplied to an engine.

### BACKGROUND OF THE INVENTION

It is known for a carburetor air-fuel mixture adjustment assembly to include a needle valve body that is threaded into a bore in a carburetor main body. The bore in such an assembly intersects a fuel passage in the carburetor main body. The needle valve body has a shank with a tip, a head and an exteriorly threaded portion between them received in a complimentary threaded portion of the bore. The tip of the valve body is positioned in axial alignment with an annular seat or orifice of the fuel passage and can be axially advanced and retracted by rotation of the needle valve body within the receptacle to adjust the air-fuel ratio of a fuel mixture. Axial advancement and retraction of the tip relative to the seat or orifice respectively decreases and increases the cross-sectional area of the flow path through the seat or orifice to decrease and increase the amount of fuel that can flow through the orifice. The needle valve body is rotated by using a tool such as a screwdriver to engage a screw head of the valve body that protrudes from the carburetor main body. In some such assemblies, to prevent inadvertent or uncommanded rotation of the valve body within the bore, a tamper-resistant cap is placed over the screw head and is secured to, or braced against an adjacent structure.

Fuel mixture adjustment assemblies of this type have “slop” or clearance between the respective threaded portions of the needle valve body and the bore which permits some axial and/or radial movement of the tip within the seat or orifice, such as when force is applied to the valve body head or while encountering engine vibration. This axial and/or radial movement can change the shape and size of the effective flow area around the tip enough to result in fuel flow rate changes of up to 20% from an optimum fuel flow rate as determined by the manufacturer. Fuel flow rate changes caused by needle “slop” can result in excessively rich or lean fuel mixtures that undesirably increase exhaust emissions and/or adversely affect engine performance. Therefore, it is desirable to reduce fuel flow fluctuations through the seat or orifice and the resulting affects on exhaust emissions and engine performance by limiting needle slop.

To assist in reducing fuel flow fluctuations, it is known to incorporate a spring between the protruding head of the needle valve body and the main body of the carburetor. This creates an axial preload between the mating threads of the needle valve body and the receptacle, thereby reducing the amount of radial and/or axial deflection of the needle valve body within the receptacle and inhibits unintended rotation of the needle valve body.

Another example of a stabilizing system for an air-fuel mixture adjustment needle valve is disclosed in Japanese Patent Application No. 7-346529 filed Dec. 12, 1995 (Japanese Laid-open Publication No. 9-158783 published Jun. 17, 1997). The Japanese Patent Application discloses a carburetor air-fuel mixture adjustment assembly as described above and including a pressure plate made of an elastic material and overlaid on an outer surface of the carburetor main body. The pressure plate includes an aperture that a threaded protruding portion of the needle valve body must be inserted through during assembly. The presence of the pressure plate limits movement of the needle valve body within the receptacle by holding the needle valve body in a centered position.

The carburetor air-fuel mixture adjustment assembly disclosed in this Japanese Patent Application also includes an annular sealing member coaxially disposed between the shank portion of the needle valve body and the receptacle such that the sealing member is compressed between the receptacle and the shank to prevent air from passing between the receptacle and valve body and leaking into the fuel passage. The sealing member is essentially an elongated tube of constant inner and outer diameter that must be forced over a shank portion of the needle valve body then forced into a section of the receptacle shaped to receive the sealing member during assembly. To produce an effective seal against air leakage into the carburetor, machining tolerances must be tight for inner and outer circumferential surfaces of the sealing member, an outer circumferential surface of the shank portion of the valve body, and an inner circumferential surface of the portion of the receptacle receiving the sealing member.

### SUMMARY OF THE INVENTION

An apparatus for adjusting the air-fuel ratio of a carburetor with a needle valve body received in a receptacle of the carburetor body and having a seal between them preferably adjacent the tip and a retainer between them preferably adjacent the head of the needle valve body. The receptacle intersects a fuel passage in the carburetor main body. The needle valve body has a shank with a threaded portion between the tip and the head and is engaged with a complimentary threaded portion in the receptacle so that rotation of the needle valve body axially advances and retracts the tip relative to a seat or orifice to respectively decrease and increase the flow area of the orifice through which fuel may pass. To prevent tampering with a factory setting of the needle valve body, preferably its head, may be received in a recess in the main body of the carburetor. Additionally, its head may have an unconventional, non-circular shape, thus requiring a specialized tool to rotatably adjust the needle valve body.

Preferably, a generally annular seal is concentrically disposed on the shank of the needle valve body adjacent the tip and is compressed between the receptacle and the shank. A generally annular retainer is preferably disposed concentrically on the shank adjacent the head of the needle valve body and is compressed between the receptacle and the shank. The retainer laterally biases the threaded portion of the needle valve body into engagement with an interiorly threaded portion of the receptacle and ensures alignment of the intermediate portion of the needle valve body with the receptacle, thus inhibiting radial or lateral movement of the needle valve body within the receptacle. The retainer also inhibits unintended rotation of the needle valve body. The retainer assures that a constant fuel calibration setting is maintained through the orifice by resisting axial and radial needle displacement and rotation due to such factors as external forces applied to the head of the needle valve body or engine vibration.

Objects, features and advantages of the invention include providing an assembly that maintains a fuel calibration setting in use by resisting inadvertent or unintended needle displacement between the needle valve body and the receptacle, permits use of a shorter length, reduced mass, and less expensive needle valve body, reduces the effects of vibration of the needle valve body, prevents inadvertent adjustment of the needle valve body, provides additional sealing between the needle valve body and receptacle to maintain the proper air-fuel ratio of the fuel mixture, reduces the complexity of the machining required to manufacture the needle valve body and the cost to manufacture the needle valve body, reduces offset or eccentricity between the needle valve body and the receptacle, and improves the ease of manufacturing and assembly of a carburetor air-fuel mixture adjustment assembly.

### BRIEF DESCRIPTION OF THE DRAWINGS

These and other objects, features and advantages of this invention will become apparent from the following detailed description of the preferred embodiments and best mode, appended claims, and accompanying drawings in which:

FIG. 1 is a perspective view of a carburetor including a fuel mixture adjustment assembly constructed according to a currently preferred embodiment of the invention;

FIG. 2 is a fragmentary cross-sectional side view of the carburetor and assembly of FIG. 1;

FIG. 3 is a side view of a needle valve body of the assembly of FIG. 1;

FIG. 4 is an end view of the needle valve body of FIG. 3;

FIG. 5 is an end view of a sealing member of the assembly of FIG. 1;

FIG. 6 is a cross-sectional side view of the sealing member of FIG. 5 taken along line 6-6 of FIG. 5;

FIG. 7 is a partial cross-sectional side view of a specialized tool used for adjusting the needle valve body; and

FIG. 8 is an end view of a head of the tool of FIG. 7 looking in the direction of arrows 8-8 of FIG. 7.

### DETAILED DESCRIPTION

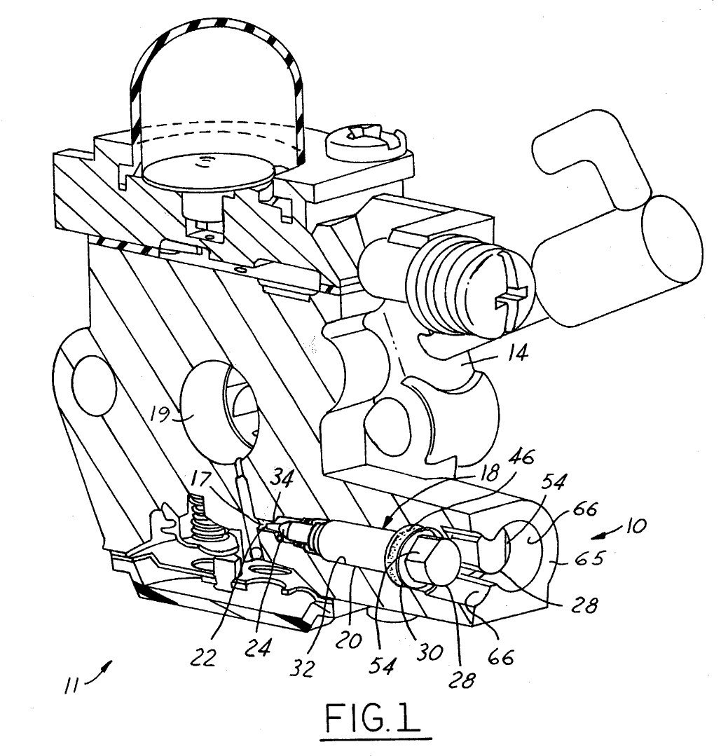

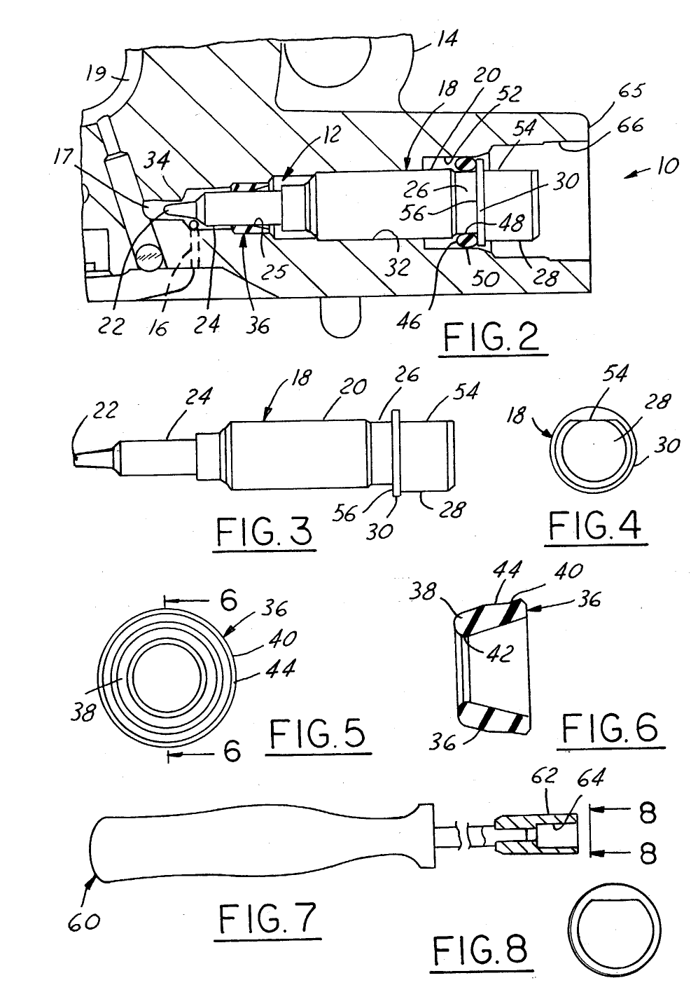

FIGS. 1 and 2 illustrate an apparatus 10 embodying his invention for adjusting the air-fuel ratio of a fuel mixture supplied by a carburetor 11. The apparatus 10 includes a receptacle 12 formed in a main body 14 of a carburetor and a needle valve body 18 having a tip 22 concentrically supported within the receptacle 12 so that in operation, the tip 22 is disposed in an axially aligned orientation relative to a seat or orifice 34. The tip 22 can be axially advanced and retracted by rotating the needle valve body 18 within the receptacle 12. This axial movement of the tip 22 relative to the orifice 34 changes the effective flow area of the orifice 34 to adjust the air-fuel ratio of the fuel mixture.

Carburetor 11 may be a diaphragm carburetor, float bowl carburetor or other type of carburetor which utilizes a needle valve to adjust the air-fuel ratio of a fuel mixture supplied by the carburetor. The carburetor body 14 has a first fuel passage 16 and a second fuel passage 17 with the orifice 34 providing a flow path between the two passages 16, 17. The receptacle 12 intersects the first fuel passage 16 so that the fuel mixture flows around the tip 22 and through the orifice 34 and into the second fuel passage 17. The fuel mixture then flows from the second fuel passage 17 into an air and fuel mixing passage 19.

The carburetor body 14 has an extended boss 65 with a recess 66 opening into an end opposite the orifice 34. The recess 66 transitions into a retainer seat 52 that is preferably necked down from the recess 66. The receptacle 12 has an interiorly threaded portion 32 that is preferably necked down from the retainer seat 52. A seal seat 25 is constructed between the interiorly threaded portion 32 and the orifice 34.

The needle valve body 18 has a shank 24 with an integral tip 22, head 28 and threaded portion 20 between them which in assembly mates with complimentary threads 32 of the receptacle 12. An intermediate portion 26 is integrally disposed between the head 28 and the threaded portion 20 and adjacent to a flange 30 of the head 28 defines a shoulder 56.

At least a portion of the head 28 of the needle valve body 18 is non-circular and is shown here as being generally D-shaped. The head 28 has a flat surface 54 extending axially from an end of the needle valve body 18 to the flange 30. The non-circular head 28 requires an unconventional tool 60 (not normally available to end users of the carburetor), as shown in FIGS. 7 and 8 to engage the head 28 and rotatably adjust the needle valve body 18 within the receptacle 12. The need for an unconventional specialized tool helps to ensure that the needle valve body 18 will not be adjusted by an end user from a factory setting required to comply with environmental standards and restrictions as may be governmentally mandated and/or to avoid adverse or deleterious engine operation.

As shown in FIGS. 7 and 8, the specialized tool 60 for engaging the generally D-shaped head 28 has an engagement socket 62 with an outside diameter sized to fit within the recess 66 and a receptacle portion 64 of the socket 62 having a generally D-shaped cavity that is complimentary to and slightly larger than the head 28. This permits the socket 62 to fit over the head 28 for engaging and rotating the head 28 to adjust the needle valve body 18 to the desired setting.

To further inhibit adjustment of the needle valve body 18 from the preferred factory setting beyond the protection provided by the generally D-shape of the non-circular head 28, in assembly, the head 28 is preferably wholly received within the recess 66 of the main body 14. The recess 66 has an internal diameter and an axial depth sized to prevent readily available tools (such as a needle nose pliers) from engaging the head 28 of the needle valve body 28, thereby making it difficult for anyone not having the specialized tool 60 from tampering with or changing the factory setting of the needle valve body 18. By preventing tampering with the setting of the needle valve body 18 in this manner, no additional components may be required to prevent tampering. The prevention of tampering with the needle valve body 18 setting helps to ensure that the carburetor remains in compliance with the emissions standards that may be established by the EPA or other governmental organizations/agencies and/or the desired factory setting for proper operation of the engine.

An annular seal 36 is concentrically disposed on the shank 24 of the needle valve body 18. The seal 36, best shown in FIGS. 5 and 6, is compressed between the receptacle 12 and the shank 24 of the needle valve body 18. This stabilizes the tip 22 relative to the needle orifice 34 and prevents ambient air from passing between the needle valve body 18 and the receptacle 12 and entering the fuel passage 17. Therefore, the seal 36 helps to maintain the desired air-fuel ratio of the fuel mixture to both improve the running performance of the engine and decrease exhaust emissions.

The seal 36 has a generally frustroconical shape that includes integrally formed annular expansion and compression regions 38, 40. The expansion and compression regions 38, 40 are disposed adjacent respective axially opposite ends of the sealing member 36 and are configured to engage the needle valve body 18 and the receptacle 12, respectively. The expansion and compression regions 38, 40 are configured to provide a seal between the needle valve body 18 and the receptacle 12 without requiring close machining tolerances on interfacing surfaces of the needle valve body 18, the receptacle 12 or the seal 36. The expansion and compression regions 38, 40 are also configured to compensate for any misalignment or eccentricity that might exist between the shank 24 of the needle valve body 18 and the receptacle 12. Thus, an effective seal between the needle valve body 18 and the receptacle 12 is maintained by the expansion and compression regions 38, 40 even when the needle valve body 18 is not concentrically disposed within the receptacle 12.

As best shown in FIG. 6, the expansion region 38 of the seal 36 is disposed at an axial inner end of the seal 36. The expansion region 38 has a circumferential inner contact area 42 that is configured to expand slightly in a radially outward direction when installed over and around the shank 24 of the needle valve body 18.

The compression region 40 is disposed at an axial outer end of the seal 36 opposite the inner end. The compression region 40 has a circumferential outer contact area 44 that is configured to compress radially inward when seated in the receptacle 12. The outer contact area 44 is preferably greater than the inner contact area 42 of the expansion region 38. This ensures that the seal 36 stays in place when the shank 24 of the needle valve body 18 is backed out of the receptacle 12. The amount of interference between the shank 24 and the expansion region 38 of the seal 36 is calibrated to prevent excessive drag on the shank 24 of the needle valve body 18. The seal 36 is preferably formed of a thermoplastic polymer such as acetyl, but may be made of any suitable material such as, for example, rubber or metal.

An annular retainer 46, represented here as an o-ring, is concentrically disposed about the needle valve body 18 between the intermediate portion 26 and the retainer seat 52. Preferably, the o-ring retainer 46 is disposed around the intermediate portion 26 so that in assembly, an interference or friction fit between the retainer 46 and the intermediate portion 26 causes an inner circumferential contact area 48 to expand slightly. In assembly, the threaded portion 20 and the shoulder defined by the flange 30 of the head 28 act to maintain the retainer 46 on the intermediate portion 26 of the needle valve body 18.

The retainer 46 has an outer circumferential contact area 50 that is configured to compress slightly when the retainer 46 is seated within the retainer seat 52. Therefore, the retainer 46 is compressed radially between the intermediate portion 26 of the needle valve body 18 and the retainer seat 52. The retainer seat 52 preferably has a diameter that is larger than the interiorly threaded portion 32. The retainer 46, while in compression between the intermediate portion 26 of the needle valve body 18 and the retainer seat 52 of the receptacle 12, acts to bias the threaded portion 20 of the needle valve body 18 into frictional engagement with the threaded portion 32 of the receptacle 12. The frictional engagement of the retainer 46 and the mating threads 20, 32 inhibits misalignment of the needle valve body 18 within the receptacle 12, and thus, facilitates maintaining the desired fuel-air ratio and fuel mixture flow around the needle 22 and through the needle orifice 34. In addition, the frictional engagement between the retainer 46 and the mating threads 20, 32 inhibits the inadvertent rotation or adjustment of the needle valve body 18 within the receptacle 12 due to such factors as, for example, engine vibration. It should be recognized that the retainer 46 fosters a reduction in the mass of the needle valve body 18 as shown in a preferred embodiment by effectively reducing its length. Additionally, the embodiment shown does not require a spring to establish a preload between the needle valve body 18 and the receptacle 12.

Additionally, to provide additional sealing to prevent ambient air from leaking past the threads of the needle valve body 18 and into the fuel passage 17 which would thereby affect the desired air-fuel ratio of the fuel mixture, the retainer 46 establishes an interference or compression fit between the intermediate portion 26 of the needle valve body 18 and the retainer seat 52 of the receptacle 12. To accomplish this, the inner and outer circumferential contact areas 48, 50 have an interference or compression fit with the intermediate portion 26 and the retainer seat 52, respectively. The retainer 46 is preferably formed of a thermoplastic polymer such as acetyl, but may be made of any suitable material such as, for example, plastic polymers, elastomers, thermoset polymers, rubbers or metals.

This description is intended to illustrate certain currently preferred embodiments of the invention rather than to limit the invention. Therefore, it uses descriptive rather than limiting words. Obviously, it is possible to modify this invention from what the description describes and shows. For example, it should be recognized that though the head 28 of the needle valve body 18 is shown as being D-shaped, other unconventional configurations may be used to prevent standard tools available to retail consumers from being used to adjust the needle valve body. As another example, seals or retainers of different sizes, shapes, and arrangements may be used without departing from the spirit and scope of the invention as defined in the following claims. Within the scope of the claims, one may practice the invention other than as described.

What is claimed is:

1. An apparatus for adjusting the air-fuel ratio of a fuel mixture to be supplied to an engine, comprising:
a main body having a fuel passage, a needle orifice and a retainer seat;
a receptacle constructed in the main body having an interiorly threaded portion, the receptacle communicating with the fuel passage;
a needle valve body received within the receptacle and including a tip, an exteriorly threaded portion, a head, and an intermediate portion disposed between the threaded portion and the head, the exteriorly threaded portion being in complimentary threaded engagement with the interiorly threaded portion, the tip being axially advanced and retracted relative to the needle orifice when the needle valve body is rotated within the needle valve receptacle to respectively decrease and increase the area between the needle and the needle orifice open to fuel flow; and
a retainer disposed concentrically about the needle valve body between the intermediate portion and the retainer seat and compressed between the retainer seat and the intermediate portion biasing the threaded portion of the needle valve body into engagement with the interiorly threaded portion of the receptacle to maintain alignment of the needle relative to the needle orifice to maintain a desired position of the needle valve body by inhibiting needle displacement.

2. The apparatus of claim 1 wherein the main body has an extended boss with the head of the needle valve body recessed within the extended boss.

3. The apparatus of claim 2 wherein the head of the needle valve body has an unconventional shape requiring a specialized tool for engaging the head to rotatably adjust the needle valve body within the needle valve receptacle.

4. The apparatus of claim 3 wherein the head is generally D-shaped.

5. The apparatus of claim 1 wherein the retainer has an inner circumferential contact area that is configured to expand slightly when disposed around the intermediate portion of the needle valve body, and an outer circumferential contact area that is configured to compress slightly when seated within the retainer seat.

6. The apparatus of claim 1 wherein the retainer seat is adjacent the interiorly threaded portion.

7. The apparatus of claim 6 wherein the retainer seat has a diameter larger than the interiorly threaded portion.

8. An apparatus for adjusting the air-fuel ratio of a fuel mixture to be supplied to an engine, comprising:
a main body having a fuel passage, and a needle orifice;
a receptacle constructed in the main body having an interiorly threaded portion, the receptacle communicating with the fuel passage;
a needle valve body received within the receptacle and including a shank with a tip, and a head recessed within the receptacle of the main body to inhibit tampering with the setting of the needle relative to the needle orifice, and an exteriorly threaded portion between the needle and the head, the exteriorly threaded portion being in threaded engagement with the interiorly threaded portion, the needle being axially advanceable and retractable by rotating the needle valve body within the receptacle to respectively decrease and increase the area between the needle and the needle orifice open to fuel flow.

9. The apparatus of claim 8 wherein the head of the needle valve body has an unconventional shape requiring a specialized tool for engaging the head to axially adjust the needle relative to the needle orifice.

10. The apparatus of claim 9 wherein the head is generally D-shaped.

11. An apparatus for adjusting the air-fuel ratio of a fuel mixture to be supplied to an engine, comprising:
a main body having a fuel passage, a needle orifice and a retainer seat;
a receptacle constructed in the main body and having an extended boss and an interiorly threaded portion, the receptacle communicating with the fuel passage;
a needle valve body received within the receptacle and including a needle, a head recessed within the extended boss of the main body to prevent tampering with the setting of the needle relative to the needle orifice, and an exteriorly threaded portion between the needle and the head, the exteriorly threaded portion being in threaded engagement with the interiorly threaded portion of the receptacle, the needle being axially advanceable and retractable relative to the needle orifice by rotating the needle valve body within the receptacle; and
a retainer disposed concentrically about the needle valve body and compressed between the retainer seat and the needle valve body axially biasing the threaded portion of the needle valve body into engagement with the interiorly threaded portion of the receptacle and maintaining alignment of the needle relative to the needle orifice to maintain the fuel calibration setting of the air-fuel ration by resisting needle displacement.

12. The apparatus of claim 11 wherein the head of the needle valve body has an unconventional shape requiring a specialized tool for engaging the head to axially adjust the needle relative to the needle orifice.

13. The apparatus of claim 12 wherein the head is generally D-shaped.

14. The apparatus of claim 11 wherein the main body has an extended boss with the head of the needle valve body recessed within the extended boss to prevent tampering with the setting of the needle valve body.
